(19) United States
(12) Patent Application Publication
(10) Pub. No.: US 2013/0168300 A1
(43) Pub. Date: Jul. 4, 2013

(54) SYSTEMS AND METHODS FOR SORTING RECYCLABLE OBJECTS

(71) Applicants: Richard L. MALONE, Lafayette, CO (US); Donald W. STARK, Arvada, CO (US); Roger H. GROW, Lafayette, CO (US)

(72) Inventors: Richard L. MALONE, Lafayette, CO (US); Donald W. STARK, Arvada, CO (US); Roger H. GROW, Lafayette, CO (US)

(21) Appl. No.: 13/538,756

(22) Filed: Jun. 29, 2012

Related U.S. Application Data
(60) Provisional application No. 61/502,630, filed on Jun. 29, 2011.

(51) Int. Cl. B07C 5/34

(52) U.S. Cl. CPC B07C 5/3412
USPC 209/583; 209/552

(57) ABSTRACT

A sorting system according to embodiments of the present invention includes a housing, a tray tiltably coupled to the housing and having a top surface configured to receive an object, an actuator configured to tilt the tray to at least a first position at which the object rolls or slides off of a first end of the tray, and a second position at which the object rolls or slides off of a second end of the tray opposite the first end, and an object recognition system configured to determine whether the object is a first type of object or a second type of object, wherein the actuator is configured to tilt the tray to the first position when the object is the first type of object, and wherein the actuator is configured to tilt the tray to the second position when the object is the second type of object.

### CROSS REFERENCE TO RELATED APPLICATIONS

This application claims the benefit of U.S. Provisional Patent Application Ser. No. 61/502,630 filed on Jun. 29, 2011, which is incorporated herein by reference in its entirety for all purposes.

### TECHNICAL FIELD

Embodiments of the present invention relate generally to sorting objects, and more particularly to sorting recyclable objects.

### BACKGROUND

Existing recycling kiosks, such as those for the acceptance of empty aluminum cans and plastic bottles, often have multiple slots for the acceptance of the different kinds of recyclable articles, with each slot leading to a separate collection bin. Although sorting technology is currently used in large-scale and industrial-scale recycling operations, often involving complex equipment used for products moving along conveyor belts, sorting technology is typically not employed in recycling kiosks, due to the limited space and cost constraints associated therewith.

### SUMMARY

Embodiments of the present invention include a sorting assembly with a single product receiving window, a curved tilting platform configured to receive the product, the curved tilting platform rotatable about a rotation axis, a bar code scanner, and optionally a camera, wherein the tilting platform is rotatable slightly in one rotational direction and/or the other rotational direction to rotate the product to expose the bar code, and wherein the tilting platform is rotatable further in one rotational direction and/or the other rotational direction to cause the product to roll or fall into one collection bin or another, based on the type of product. Use of a single receiving window with simple validation and sorting technology, according to embodiments of the present invention, eliminates the need for redundant validation equipment at each receiving window.

A sorting system according to embodiments of the present invention includes a housing; a tray tiltably coupled to the housing, the tray including a top surface configured to receive an object; an actuator configured to tilt the tray with respect to the housing to at least a first position at which the object, when received by the top surface, rolls or slides off of a first end of the tray, and a second position at which the object, when received by the top surface, rolls or slides off of a second end of the tray opposite the first end; an object recognition system configured to determine whether the object received by the top surface is a first type of object or a second type of object, wherein the actuator is configured to tilt the tray to the first position when the object is the first type of object, and wherein the actuator is configured to tilt the tray to the second position when the object is the second type of object.

The sorting system paragraph [0005], wherein the object recognition system includes a bar code scanner configured to scan a bar code on the object, wherein the first type of object is an aluminum beverage container, and wherein the second type of object is a plastic beverage container.

The sorting system of any of paragraphs [0005] to [0006], wherein the object recognition system further includes a camera system configured to determine whether the object is the first type of object or the second type of object based on visual characteristics of the object.

The sorting system of any of paragraphs [0005] to [0007], wherein the first end of the tray is on a first side of a plane defined by an intersection of the tilt axis and a gravitational direction, and wherein the second end of the tray is on a second side of the plane.

The sorting system of any of paragraphs [0005] to [0008], wherein the top surface is at least partially concave.

The sorting system of any of paragraphs [0005] to [0009], wherein the top surface includes a concave curvature extending from the first end to the second end, such that a cylindrical object placed onto the top surface with its object axis substantially aligned with the tilt axis is capable of rolling along an entirety of the concave curvature between the first and second ends.

The sorting system of any of paragraphs [0005] to [0010], wherein the housing includes a receiving window, and wherein the top surface is configured to receive the object inserted through the receiving window.

The sorting system of any of paragraphs [0005] to [0011], further including a light curtain sensor array configured to detect when any object passes through or extends into the receiving window.

The sorting system of any of paragraphs [0005] to [0012], further including a solenoid configured to halt movement of the tray upon detection of any object passing into or through the receiving window.

The sorting system of any of paragraphs [0005] to [0013], further including at least one position sensor configured to sense a tilt angle of the tray with respect to the housing.

The sorting system of any of paragraphs [0005] to [0014], further including a first outlet on the first side and a second outlet on the second side.

The sorting system of any of paragraphs [0005] to [0015], further including a sensor configured to detect when any object passes through or extends into the first outlet.

A method for sorting objects according to embodiments of the present invention includes receiving an object on a top surface of a tray; scanning the object with a bar code scanner to obtain a bar code number; determining based on the bar code number whether the object is a first type of object or a second type of object; and tilting the tray to cause the object to enter a first outlet based on a determination that the object is the first type of object or to enter a second outlet based on a determination that the object is the second type of object.

The method of paragraph [0017], wherein scanning the object with the bar code scanner to obtain the bar code number includes scanning the object for a second time with the bar code scanner, the method further including: scanning the object for a first time with the bar code scanner, wherein scanning the object for the first time with the bar code scanner does not result in obtaining the bar code number; and tilting the tray to cause the object to move along the top surface to expose a bar code of the object to the bar code scanner prior to scanning the object for the second time.

The method of any of paragraphs [0017] to [0018], wherein the object is substantially cylindrical, and wherein tilting the tray to cause the object to move along the top surface includes tilting the tray to cause the object to roll along the top surface to expose the bar code on the object.

The method of any of paragraphs [0017] to [0019], wherein tilting the tray to cause the object to roll along the top surface includes tilting the tray to cause the object to roll at least once back and forth along the top surface prior to causing the object to enter either the first outlet or the second outlet.

The method of any of paragraphs [0017] to [0020], wherein receiving the object on the top surface of the tray includes receiving the object through a receiving window, the method further including halting tilting of the tray upon detecting any object passing through or extending into the receiving window.

A kiosk according to embodiments of the resent invention includes: a receiving window; a sorting system including a tiltable sorting tray and an object recognition system, the tiltable sorting tray configured to receive an object inserted through the receiving window, wherein the object is one of two or more different types of objects, the sorting system configured to recognize the one of the two or more different types of the object using the object recognition system, the sorting system further configured to tilt the tiltable sorting tray in one direction or another to release the object into a particular container based on the recognition.

The kiosk of paragraph [0022], wherein the object recognition system is a bar code scanner.

The kiosk of any of paragraphs [0022] to [0023], wherein the object recognition system is a camera system.

The kiosk of any of paragraphs [0022] to [0024], wherein the object recognition system is a bar code scanner and a camera system.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 illustrates a front isometric view of a sorting kiosk, according to embodiments of the present invention.

FIG. 2 illustrates a front elevation view of the sorting kiosk of FIG. 1, according to embodiments of the present invention.

FIG. 3 illustrates another front isometric view of the sorting kiosk of FIGS. 1 and 2 housing a sorting system, according to embodiments of the present invention.

FIG. 4 illustrates another front elevation view of the sorting kiosk of FIGS. 1 to 3 housing a sorting system, according to embodiments of the present invention.

FIG. 5 illustrates a front isometric view of a sorting system, according to embodiments of the present invention.

FIG. 6 illustrates a front elevation view of the sorting system of FIG. 5, according to embodiments of the present invention.

FIG. 7 illustrates a front isometric view of the sorting system of FIGS. 5 and 6, with the sorting tray tilted in one direction approximately twenty degrees from normal, according to embodiments of the present invention.

FIG. 8 illustrates a front elevation view of the sorting system of FIGS. 5 to 7, with the sorting tray tilted in one direction approximately twenty degrees from normal, according to embodiments of the present invention.

FIG. 9 illustrates a front isometric view of the sorting system of FIGS. 5 to 8, with the sorting tray tilted in one direction approximately sixty degrees from normal, according to embodiments of the present invention.

FIG. 10 a front elevation view of the sorting system of FIGS. 5 to 9, with the sorting tray tilted in one direction approximately sixty degrees from normal, according to embodiments of the present invention.

FIG. 11 illustrates a front perspective view of an interior of a sorting kiosk and a sorting system, according to embodiments of the present invention.

FIG. 12 illustrates a front perspective view of the sorting system of FIG. 11, according to embodiments of the present invention.

FIG. 13 illustrates a perspective view through the receiving window of the sorting system of FIGS. 11 and 12, according to embodiments of the present invention.

FIG. 14 illustrates a front schematic view of a sorting tray and object, according to embodiments of the present invention.

FIG. 15 illustrates a front schematic view of a sorting tray and object, with different sorting tray and object positions superimposed thereon, according to embodiments of the present invention.

FIG. 16 illustrates a front schematic view of a sorting tray and object, with different sorting tray and object positions superimposed thereon, according to embodiments of the present invention.

FIG. 17 illustrates a sorting system, according to embodiments of the present invention.

FIG. 18 illustrates a computer system, according to embodiments of the present invention.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

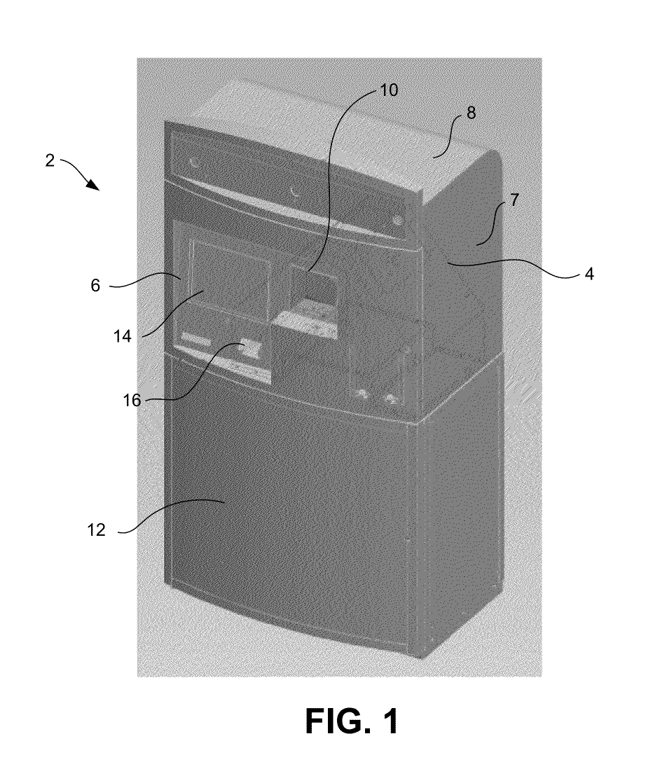

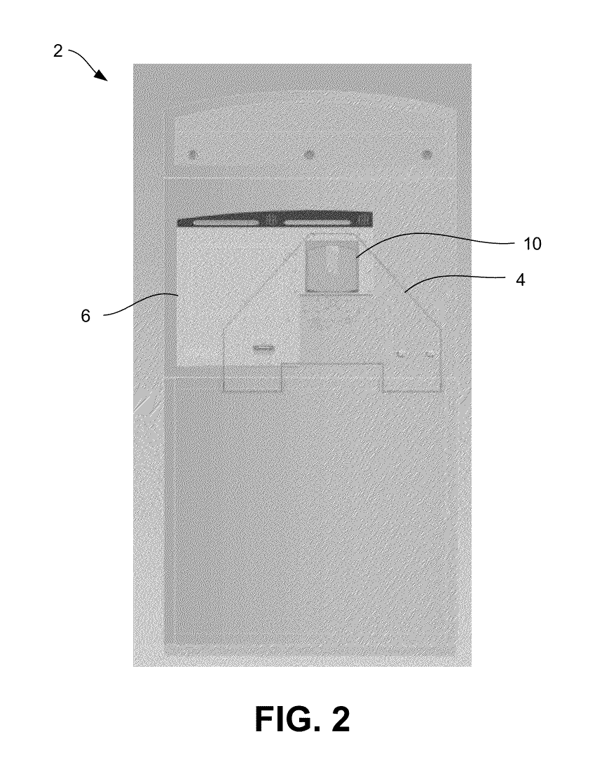

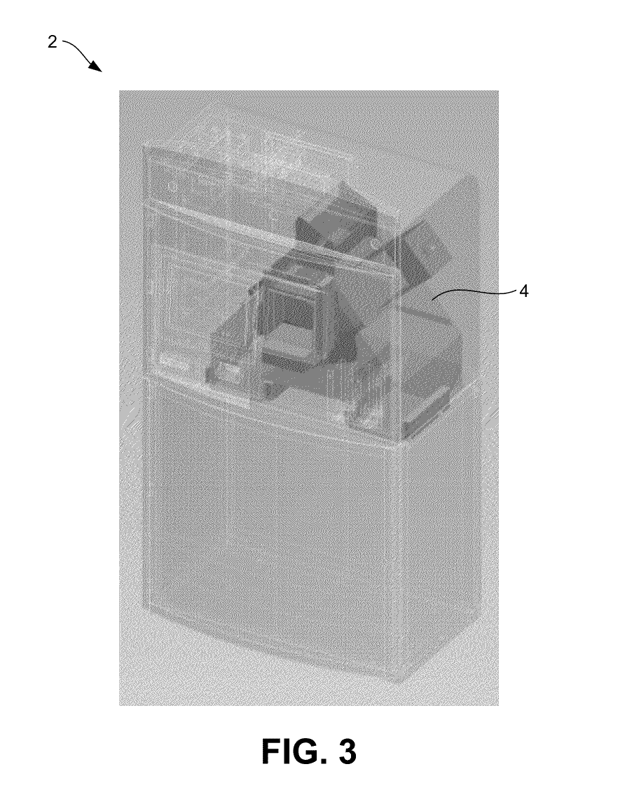

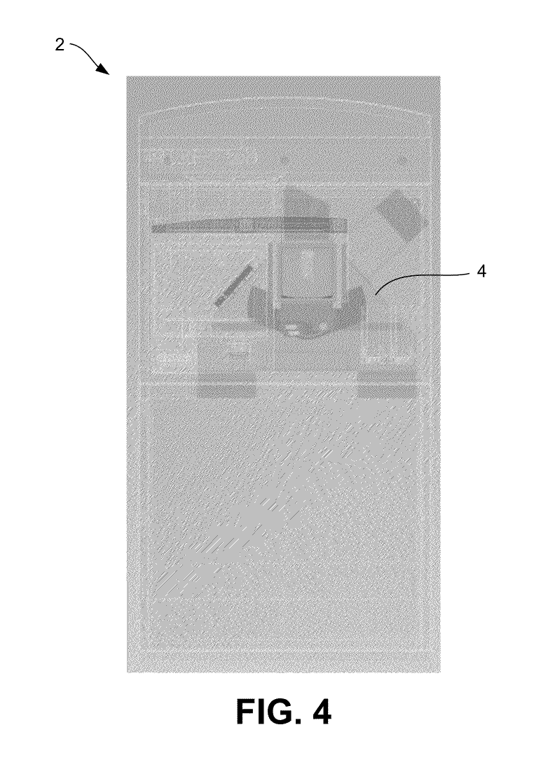

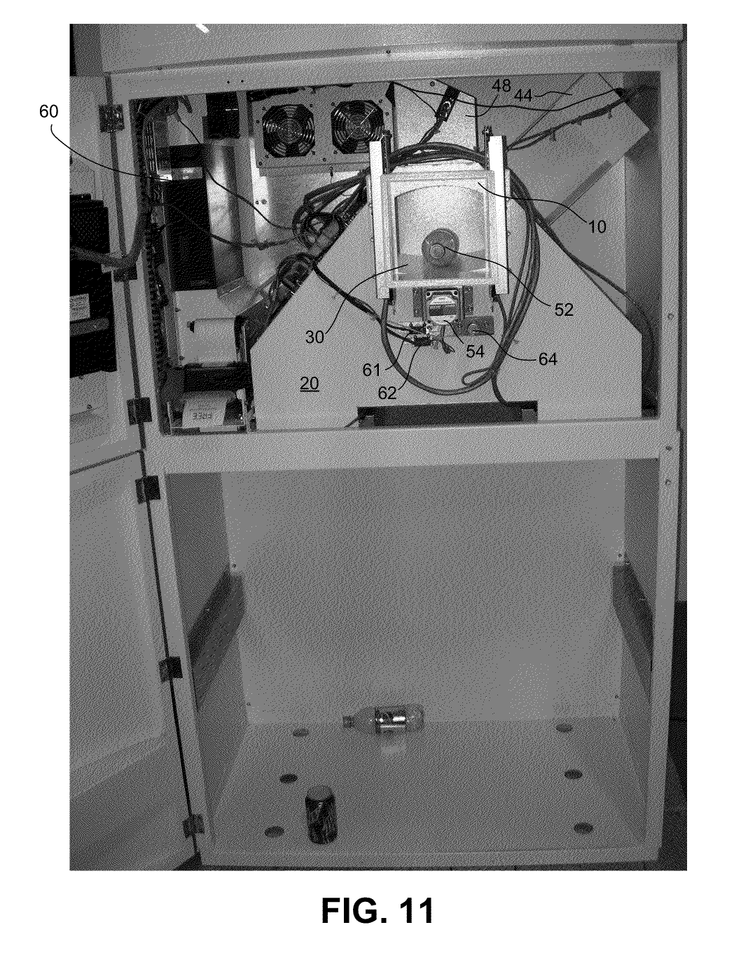

FIGS. 1 to 4 illustrate a sorting kiosk 2, according to embodiments of the present invention. Sorting kiosk 2 includes a housing 8 having a top portion 7 and a bottom portion 12. The top portion comprises a sorting system 4, a user interface system 6, and a receiving window 10, according to embodiments of the present invention. The receiving window 10 is configured to receive a product inserted therethrough and into the sorting system 4. The user interface system 6 includes a screen 14, which may be a touchscreen interface, for example, and a bar code scanner 16, according to embodiments of the present invention. The user interface system 6 may include other components, such as a card dispenser, cards, card reader, speaker, and/or printer, according to embodiments of the present invention. The bottom portion 12, the inside of which is illustrated in FIG. 11, may include two containers, one on each side of the sorting system 4, each configured to receive a particular kind of object sorted by the system. For example, the bottom portion 12 may include an aluminum can receiving bin and a plastic bottle receiving bin.

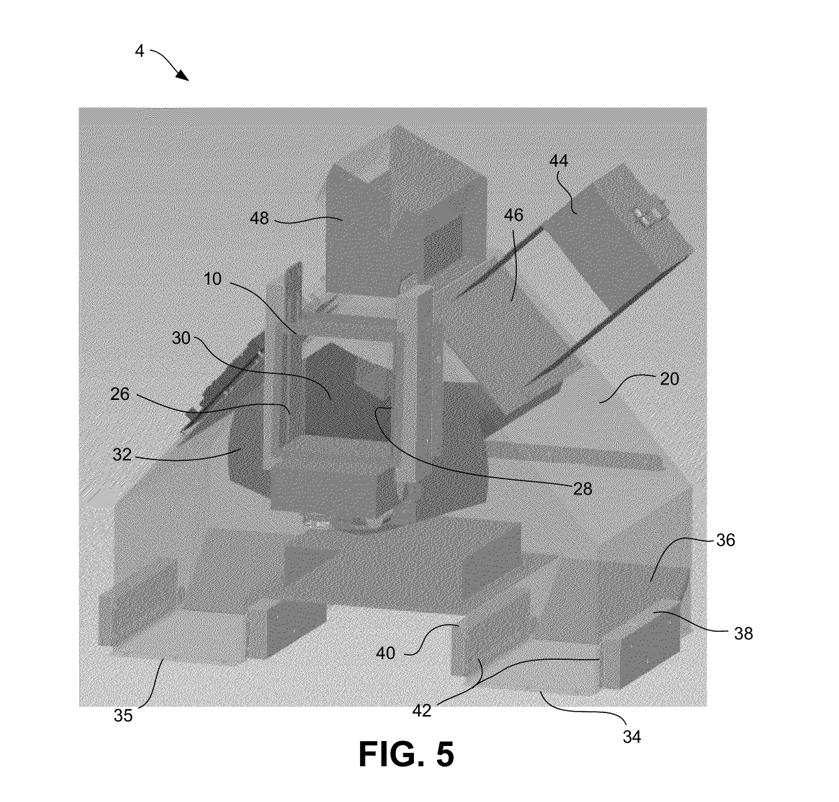

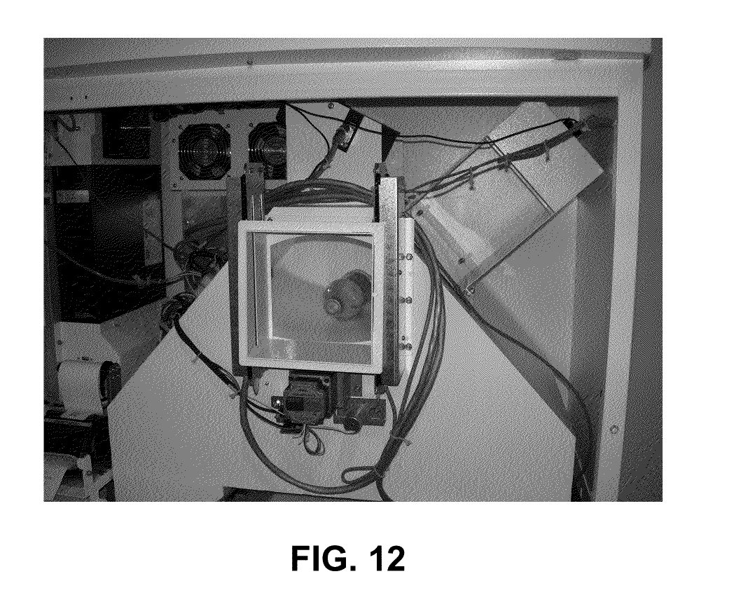

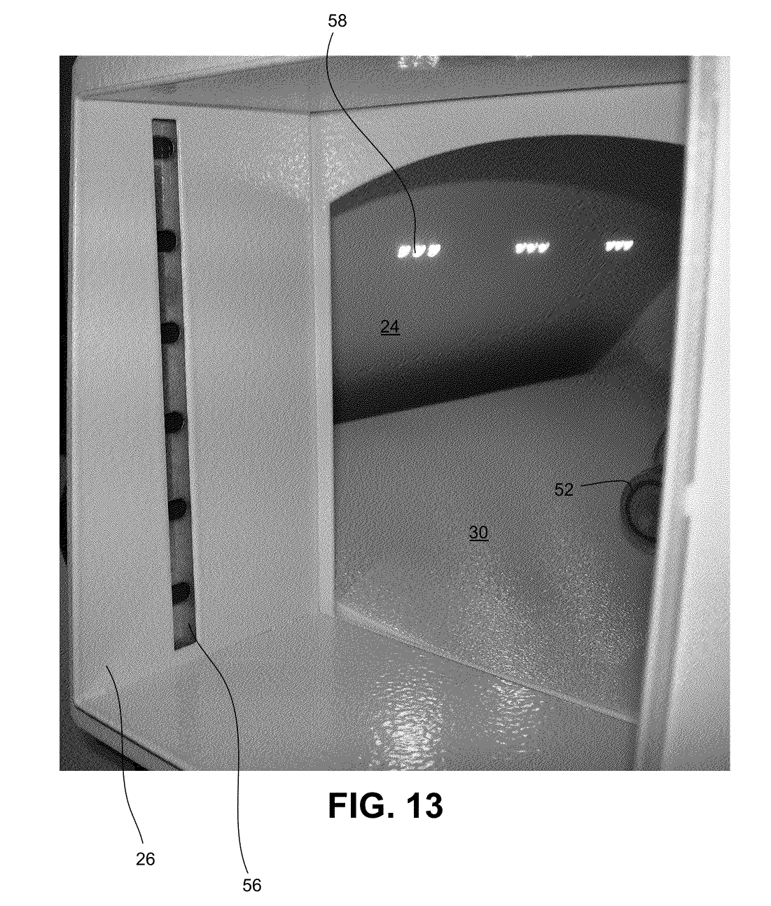

FIGS. 5 to 13 illustrate sorting system 4, according to embodiments of the present invention. Sorting system 4 includes a housing 20, the receiving window 10, a sorting tray 30, two or more outlets 34, 35 through which sorted products may exit the sorting system 4, a camera system 44, and a bar code scanner system 48, according to embodiments of the present invention. The receiving window 10 comprises a frame which includes inner sides 26, 28. One or both of the inner sides 26, 28 may include one or more sensors configured to determine whether an object is passing through the receiving window 10, according to embodiments of the present invention. For example, each of the sides 26, 28 may include all or a portion of a light curtain system 56 (see FIG. 13, for example), which employs beams of light or electromagnetic radiation which span from one side 26 to the other side 28 of the receiving window 10. The interruption of one or more of the beams notifies the sorting system 4 that an object has been placed into or through the receiving window 10 (e.g. from either the outside or inside of the window 10), according to embodiments of the present invention. Although a light curtain is described, other sensing systems may be employed. And although the sensors are described as being placed on horizontally opposed sides 26, 28 of receiving window 10, the light curtain or other sensor could alternatively or additionally be placed on top and bottom opposing sides of receiving window 10, for example.

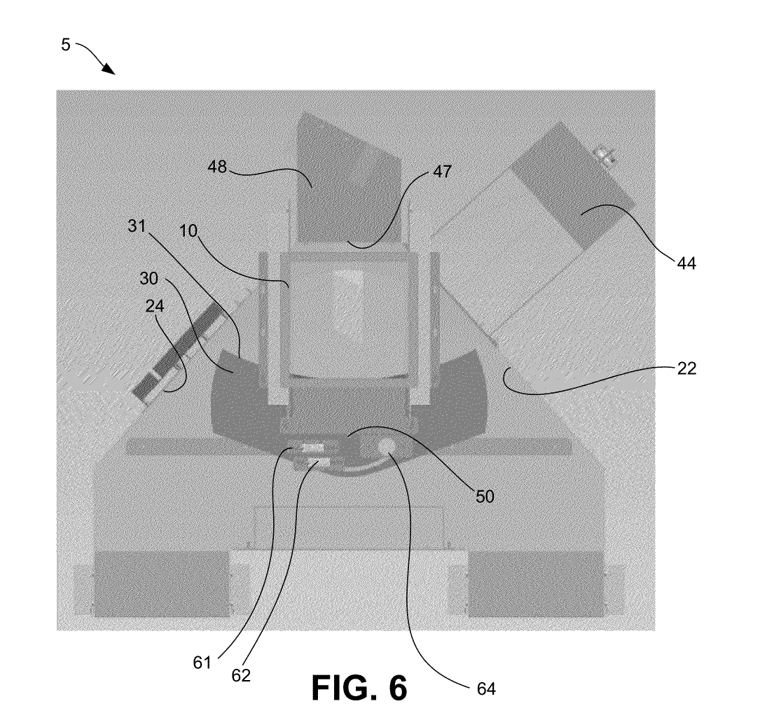

The inside of the housing 20 includes inner surface 22 and inner surface 24 (see FIG. 6), according to embodiments of the present invention. At a top surface where the two inner surfaces 22, 24 meet is mounted a bar code scanner system 48, according to embodiments of the present invention. The bar code scanner system 48 is positioned so as to scan the bar code on an object 52 on the sorting tray 30. The bar code scanner system 48 may be similar to those used at checkout counters at supermarkets, for example, and may be capable of reading bar codes in numerous different orientations, according to embodiments of the present invention. The range of the bar code scanner 44 may also be wider than the width of a typical object 52, to permit the scanning of bar codes as objects 52 are rolled back and/or forth on the sorting tray 30, according to embodiments of the present invention. The interface 47 between the bar code scanner system 48 and the housing 8 may be transparent, for example made of glass and/or plastic, in order to permit the scanner beams to reach the inside of the housing 10 and scan an object on the sorting tray 30, according to embodiments of the present invention.

A camera system 44 may be mounted to the surface 22, and a viewing window 46, such as a glass and/or plastic plate, may be located at the end of the camera system 44 along surface 22 to permit one or more cameras in the camera system 44 to view the interior area of the sorting system 4, particularly the product on the sorting tray 30, according to embodiments of the present invention. The camera used with camera system 44 may be any of a wide range of imaging and/or video devices, such as a digital camera or digital video receiver for example. The camera may be configured to sense color and/or black-and-white and/or infrared, according to embodiments of the present invention. FIG. 13 depicts lights 58 mounted to inside surface 24 to help illuminate the object 52 for sensing by the camera system 44, according to embodiments of the present invention.

The outlets 34, 35 may each include an outer side 38 and inner side 40, to which may be mounted one or more sensors 42 such as light curtain 56 described above. Light curtain 42 may be configured to detect when a sorted object passes through the outlet 34 and into its corresponding receiving container. Light curtain 42 may also be configured to detect when the sorted objects have accumulated within the underlying container high enough to interrupt the light curtain, thus indicating that the container is full or should be emptied soon, according to embodiments of the present invention. One or more ramps 36 may be located above the outlet 34 in order to direct the sorted objects to the outlet 34 as the sorted objects slide or roll or drop off of the sorting tray 30, according to embodiments of the present invention.

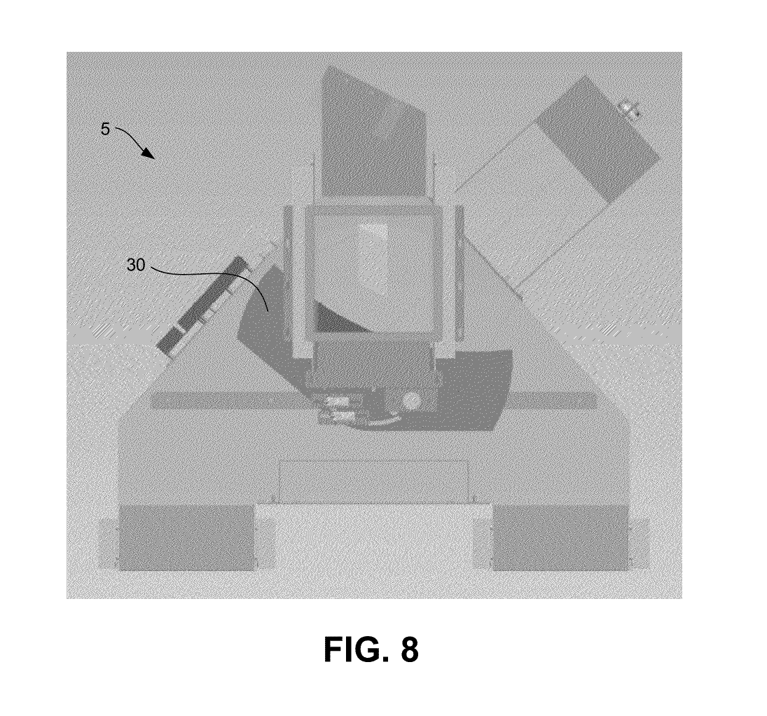

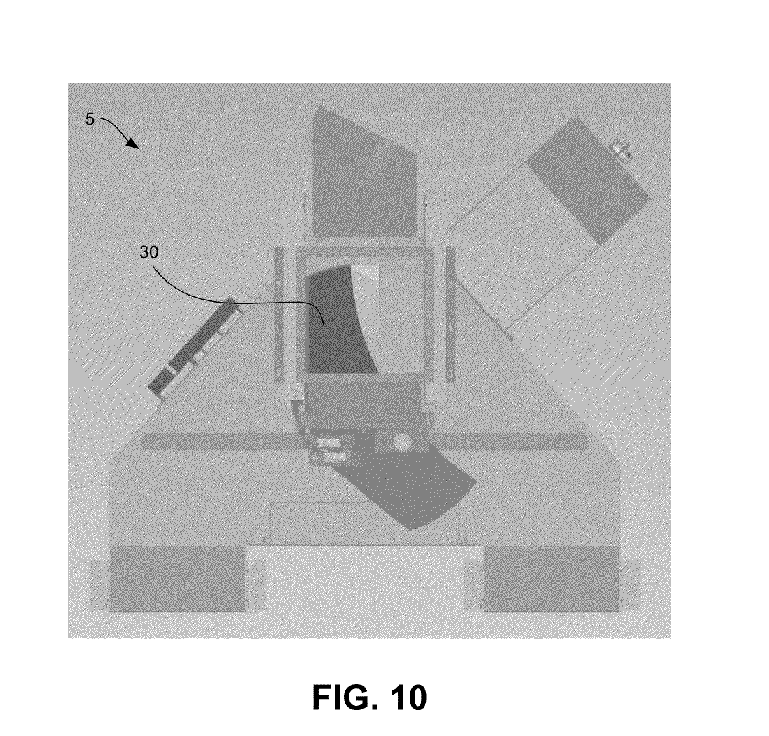

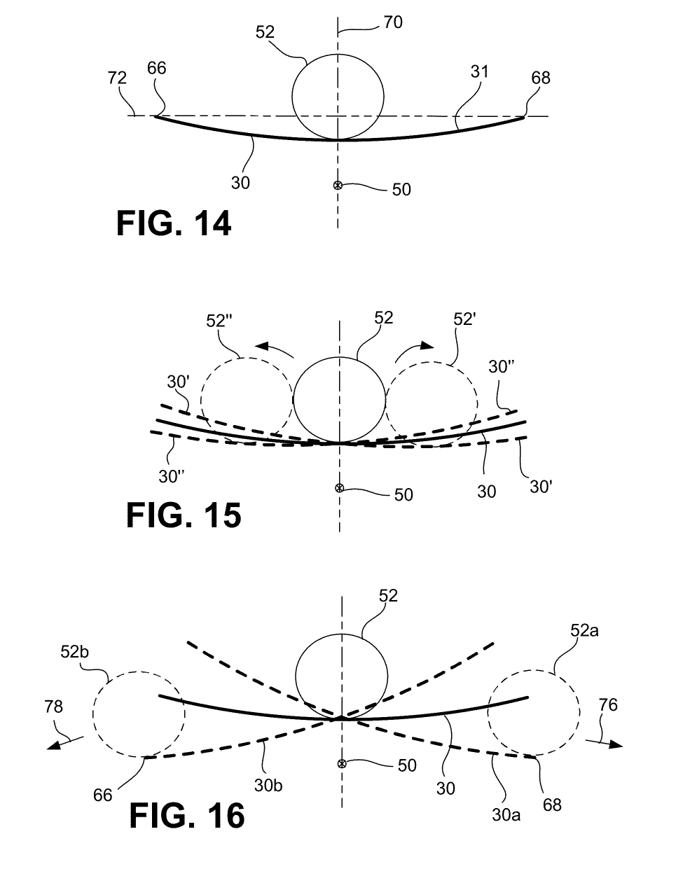

The sorting tray 30 includes a top surface 31 having an at least partially concave shape (as illustrated in the front view of FIG. 6 and in FIGS. 14-16). Sorting tray 30 pivots about pivot point 50, according to embodiments of the present invention. FIGS. 6 and 14 illustrate the sorting tray 30 in a neutral position, in which an object 52 placed onto the concave top surface 31 does not roll to one side or the other due to the concavity. The sorting tray 30 further includes a front surface 32 (see FIG. 5), which is configured to prevent insertion or placement of any objects under the top surface 31 when the sorting tray 30 is rotated to angles that would otherwise expose the underside of the top surface 31 within the receiving window 10, according to embodiments of the present invention. This is illustrated in FIGS. 8 and 10, for example, in which the sorting tray 30 is rotated toward side 22 by twenty degrees and sixty degrees, respectively. The sorting tray 30 rotation angle may be measured with respect to an imaginary line extending from the pivot point 50 normal to the top surface 31, which would extend vertically in the neutral position in the plane of FIG. 6 (in a direction from the top to bottom of FIG. 6), according to embodiments of the present invention. This imaginary line would be extending at an angle of twenty degrees in FIG. 8 with respect to the same line in FIG. 6, and at an angle of sixty degrees in FIG. 10 with respect to the same line in FIG. 6, according to embodiments of the present invention.

The pivoting or rotation or tilting of the sorting tray 30 may be driven by an actuator, for example a motor, for example a stepper motor 54 mounted to an outside of the sorter housing 20 (see FIG. 11), according to embodiments of the present invention. The tilting of the sorting tray 30 may be stopped at a particular position with the stepper motor 54 and/or with the use of one or more solenoids, according to embodiments of the present invention. The tray 30 is tiltably coupled to the housing 8, for example via a shaft. Such a shaft may have a longitudinal axis which coincides with the tilt axis about which the sorting tray 30 tilts or pivots. The shaft may be stationary with respect to the housing 8 and the tray 30 may tilt about the shaft; alternatively, the shaft may be stationary with respect to the tray 30 and the shaft and tray may tilt about the housing. One of ordinary skill in the art, based on the present disclosure, will appreciate numerous ways in which the tray 30 may be tiltably coupled with the housing 8. As used herein, “tiltably coupled” is used in its broadest sense to refer to any coupling, direct or indirect, which permits one object to tilt or rotate with respect to another object. Although a single pivot axis 50 is shown, “tiltably coupled” also includes coupling which permits a tilting action of tray 30 without the use of a single pivot axis 50, for example through the use of multiple-bar kinematic linkages between the actuator 54 and the tray 30.

According to some embodiments of the present invention, the shaft which coincides with the pivot axis 50 is the shaft of the motor 54 itself, which directly drives the tilt angle of the tray 30. According to other embodiments, the actuator 54 is mechanically coupled to the tray 30 via gears, pulleys, belts, levers, cams, and/or a combination thereof. According to some embodiments, the actuator 54 is two or more actuators. According to some embodiments, the actuator 54 employs linear motion rather than, or in addition to, rotational and/or tilting motion; for example, a linear actuator 54 may be located under each end of the tray 30 and may raise and/or lower that particular end of the tray 30 in order to achieve the tilting of the tray 30.

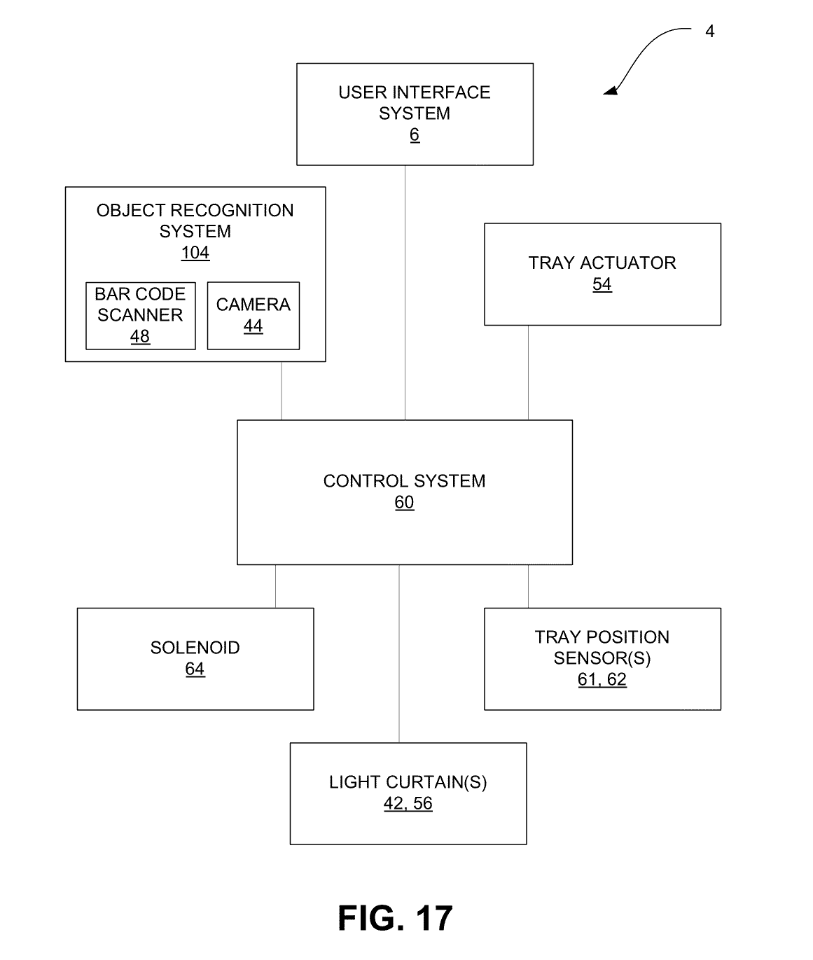

FIG. 11 also illustrates a control system 60, which may include a processor and memory. As illustrated in FIGS. 11 and 17, control system 60 may be communicably coupled with the tray actuator and/or sorter control motor 54, the one or more solenoids 64 and/or position sensors 61, 62, the light curtains 56, 42, the object recognition system (including, for example, the camera system 44 and the bar code scanner system 48), and/or the user interface system 6, according to embodiments of the present invention. As used herein, the phrase “communicably coupled” is used in its broadest sense to refer to any coupling whereby information may be passed. Thus, for example, communicably coupled includes electrically coupled by, for example, a wire; optically coupled by, for example, an optical cable; and/or wirelessly coupled by, for example, a radio frequency or other transmission media. “Communicably coupled” also includes, for example, indirect coupling, such as through a network, or direct coupling. In addition to being communicably coupled to the various devices and sensors of the sorting system 4, the control system 60 may also be communicably coupled to a remote system, for example a remote administration, control, and/or monitoring station. Such remote connection may be established with an internet protocol connection over the internet, for example.

The control system 60 (or other similar hardware or software control system) may include instructions in its memory which, when executed by its processor, cause the sorting system 4 to perform certain tasks in an automated fashion, as described herein. For example, when an object 52, such as an aluminum can or plastic bottle, is passed through light curtain 56 in receiving window 10, the system 4 may then use the camera 44 to determine whether an object 52 is present on the top surface 31. Once the light curtain 56 again senses an uninterrupted status (e.g. when the user's hand has been withdrawn from the receiving window 10 after inserting the object 52), the system 4 may begin to sort the object 52. The object may be of a standard kind, for example the kind of object which includes a bar code, similar to those used to scan and identify products at a store. The object may be, for example, an aluminum can or plastic bottle. Because the vast majority of aluminum cans and plastic bottles include bar codes which are readily recognizable by a bar code scanner 48 and processor system to identify details about the item, the bar code scanner 48 may be used to determine whether the inserted object 52 is an aluminum can or a plastic bottle. For example, the control system 60 may scan a bar code to obtain a bar code number, and then match the bar code number to an existing database to determine the identity of the particular beverage product, which may then be used to directly or indirectly determine whether the product is an aluminum can, a plastic bottle, or some other type of material or product, according to embodiments of the present invention.

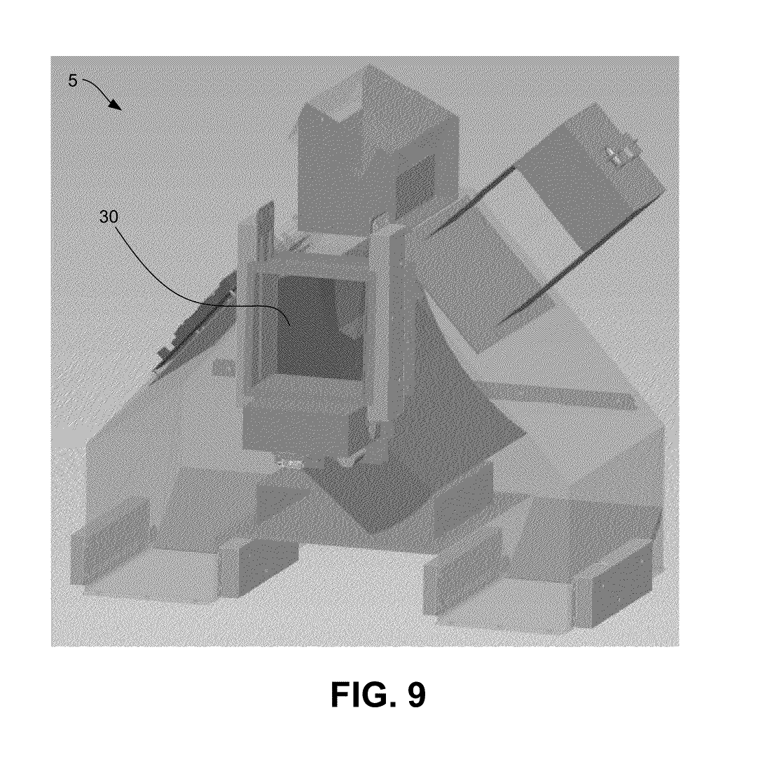

The camera system 44 may optionally be used to confirm and/or validate the identification of the item, or supplement the sorting process in cases in which the object 52 lacks a bar code, or has a bar code which is not recognized by system 4. The camera system 44 may capture one or more images of the object 52, for example an outline or rough image of the object 52, and compare it with images of known objects, according to embodiments of the present invention. In this way, the system 4 performs a statistical image comparison to confirm whether the object 52 is an aluminum can, plastic bottle, or something else, according to embodiments of the present invention. As such, the system 4 does not identify the object 52, but merely recognizes features of the object 52 which tend to confirm or validate the sorting criteria. The system 4 may be configured to tilt the sorting tray 4 toward one side (either 22 or 24) if the object 52 is an aluminum can, and to tilt the sorting tray 4 toward the other side (22 or 24) if the object 52 is a plastic bottle. For example, an aluminum can receptacle may be located beneath outlet 34. Upon recognizing the object 52 as an aluminum can, the sorting tray 30 tilts toward side 22 (for example, as illustrated in FIGS. 9 and 10), causing the object 52 to roll, slide, or fall off of sorting tray 30 and through outlet 34. As the object 52 passes through outlet 34, the sensors 42 detect its passage to confirm the deposit of the object 52 into the proper bin, according to embodiments of the present invention.

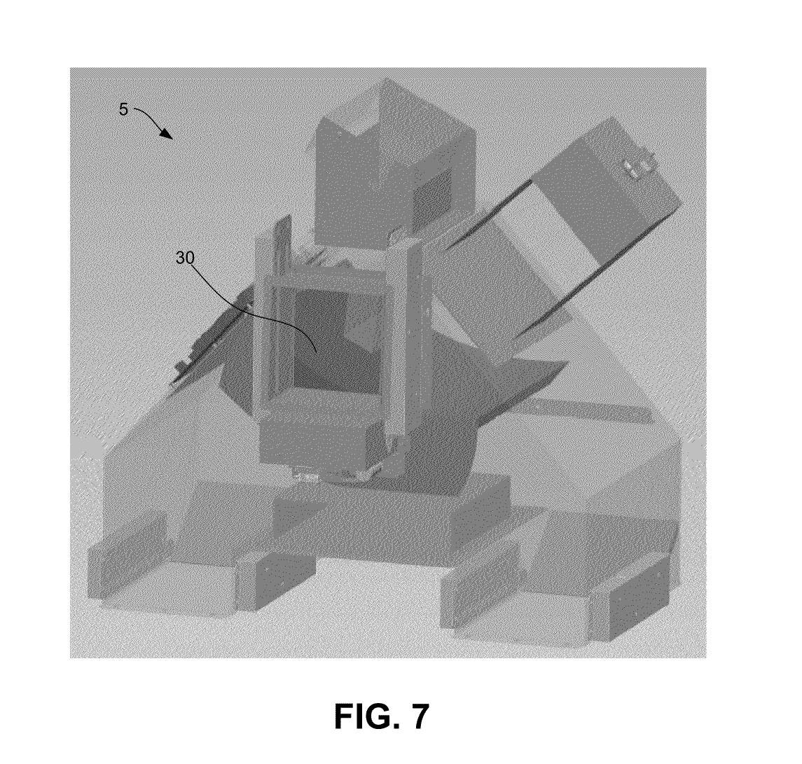

If the bar code on the object 52 is not visible to, or initially scanned by, the bar code scanner 48 after initial placement on sorting tray 30, the system 4 may tilt or rock the tray 30 towards one direction and/or back toward the opposite direction in order to roll or flip the object 52, thus exposing the bar code to the bar code scanner 48. This slight tilting may be done at angles less than those which permit the release of the object 52, for example the smaller angle shown in FIGS. 7 and 8. As such, the recognition of the object 52 and sorting of it may occur even as the object 52 is moving (e.g. rolling) across the top surface 31 of the sorting tray 30, according to embodiments of the present invention.

This is illustrated in further detail in FIGS. 14 and 15. FIG. 14 illustrates a schematic front view of a sorting tray 30, with surface 31 being the top surface of the tray 30, the tray having opposed ends 66, 68. According to some embodiments of the present invention, the top surface 31 is concave, and may follow a radius of curvature. Line 70 is normal to such radius of curvature and is located between ends 66 and 68. The angle through which line 70 rotates when the sorting tray 30 tilts may be referred to as the tilt angle. Therefore, in the front view of FIG. 14 (taken along the direction of the tilt axis 50), the normal line 70 is at a tilt angle of zero degrees. Normal line 70 may also be described as being perpendicular to a line 72 connecting ends 66 and 68. Although a symmetric top surface 31 is illustrated, the top surface 31 may alternatively be asymmetric from the viewing angle of FIG. 14, may be concave over only a portion of the surface 31, and may have other shapes and/or curvatures.

FIG. 15 illustrates the sorting tray 30 in a neutral position (in solid lines), and also illustrates in phantom lines a position 30′ of the tray 30 when the tray 30 is tilted clockwise about pivot axis 50 (e.g. about a shaft) from the view of FIG. 15. FIG. 15 also illustrates in phantom lines a position 30″ of the tray 30 when the tray 30 is tilted counterclockwise about pivot axis 50 from the view of FIG. 15. When the tray 30 is tilted to position 30′, object 52 rolls toward position 52′, and when tray 30 is tilted to position 30″, object 52 rolls toward position 52″, according to embodiments of the present invention. The tilting of tray 30 illustrated in FIG. 15 may be used to roll the object 52, for example an aluminum can or plastic bottle, back-and-forth. This procedure may be used one time, and/or multiple times, in order to attempt to expose a bar code on the object 52 to bar code scanning system 48. This rolling may be timed so that any momentum of the object 52 in one direction is quickly counter-acted by a tilt in the opposite direction, and/or a subsequent dampening of the rolling in order to bring the object 52 back to a resting position or a position in which the object 52 will not roll off of the tray 30, according to embodiments of the present invention.

As shown in FIG. 15, the object 52 may be rolled far enough to each side to fully expose the surface of the object 52 which is not visible in the neutral position. According to some embodiments of the present invention, the bar code scanner 48 first tries to scan a bar code on the object 52 when the object 52 is in a substantially stationary and/or neutral position. If the bar code scanner 48 is unsuccessful in capturing a bar code, then the control system 60 may initiate this “rocking” sequence of the tray 30 to roll and/or slide the object 52 back and/or forth across the tray 30. The bar code scanner 48 may continuously scan the object 52 for bar codes throughout such rocking motion, and/or at periodic intervals during such motion. The bar code scanner 48 may also be configured to scan a bar code on the object 52 multiple times for validation, according to embodiments of the present invention. Such a rocking motion may be configured, either according to the timing of the rocking tilts, and/or the maximum tilt angles employed in the rocking motion, to prevent the object 52 from rolling off of the tray 30 until the type of object 52 is identified by control system 60.

Once the type of object 52 is identified by the object recognition system 104 and/or control system 60, the control system 60 instructs the actuator 54 to tilt the tray 30 toward one side or another based on the type of object 52. For example, the sorting system 4 may be configured to sort aluminum cans and plastic bottles from one another. If the object 52 is identified as an aluminum can, the tray actuator 54 may be controlled to tilt the tray 30 clockwise about tilt axis 50 to the position 30a of FIG. 16, which will cause object 52 to roll and/or slide or otherwise move toward position 52a and off of edge 68 in the direction of arrow 76, according to embodiments of the present invention. The aluminum can may then slide into and/or fall through outlet 34, and into a receptacle configured to gather aluminum cans, according to embodiments of the present invention. If the object 52 is identified as a plastic bottle, the tray actuator 54 may be controlled to tilt the tray 30 counterclockwise about tilt axis 50 to the position 30b of FIG. 16, which will cause object 52 to roll and/or slide or otherwise move toward position 52b and off of edge 66 in the direction of arrow 78, according to embodiments of the present invention. The plastic bottle may then slide into and/or fall through outlet 35, and into a receptacle configured to gather plastic bottles, according to embodiments of the present invention.

Although FIGS. 15 and 16 illustrate discrete positions of tray 30 when tilted about tilt axis 50, the tray 30 may be smoothly and continuously tilted to, through, and between any number of tilt angles both smaller than and greater than those particular tilt angles illustrated, in both the clockwise and counterclockwise directions. Also, based on the disclosure provided herein, one of ordinary skill in the art will appreciate that the tilt angles and rocking motion may be customized or selected based on the radius of curvature of surface 31 and/or the diameter or size of the object 52 and/or other factors, according to embodiments of the present invention. Also, the distance between the tilt axis 50 and the surface 31 may vary. For example, the tilt axis 50 may be coincident with the surface 31 in some embodiments. In other embodiments, the tilt axis 50 is further away or closer to the surface 31 than shown in FIGS. 14-16, or on the other side of surface 31.

The sensors 56 may also be used by the system 4 as a safety and/or fraud prevention mechanism. For example, after the sorting process has begun, if the system 4 senses any object interrupting the light pattern over the receiving window 10, the system may be configured to freeze all movement, including tilting movement of the sorting tray 30, according to embodiments of the present invention. After the sorting process has begun, if the system 4 senses any object added to the tray 30 in addition to the object 52 previously present (for example by using the camera system 44 to notice a shape change, and/or by recognizing two distinct bar codes), then the system 4 may be configured to return the tray 30 to the neutral position and display a message to the user via the screen 14, according to embodiments of the present invention.

The system 4 may also include one or more sensors configured to sense or determine the moment of inertia of the sorting tray 30 and its object 52 by tilting and/or rocking the object 52 back and/or forth. Given the known moment of inertia of the tray 30, this permits system 4 to determine if the object 52 is too dense or heavy to be an empty aluminum can or an empty plastic bottle. For example, such a moment of inertia calculation can indicate the presence of a glass bottle, or a beverage container which is not yet empty or fully empty, according to embodiments of the present invention. The camera system 44 may optionally be used to improve this detection process by estimating a volume or perimeter shape of the object 52, according to embodiments of the present invention. Such tilting of an object 52 back and/or forth, along with speed and/or position sensors, may also permit the determination of an object's weight, according to embodiments of the present invention.

The solenoid 64 may be configured to lock the sorting tray 30 in a particular angular orientation. For example, when a user puts a hand into the receiving window 10 while the sorting process is happening, the step motor controlling the rocking of the sorting tray 30 not only stops the sorting tray 30 from moving, but also the solenoid 64 engages the sorting tray 30, for example via a slot, notch, hole, or other interface, to lock the sorting tray 30 into position. The solenoid 64 may also be engaged with the sorting tray 30 when the sorting tray 30 is in the neutral or upright position, in order to prevent the user from overpowering the step motor by manually turning the sorting tray 30, according to embodiments of the present invention. Various types of solenoids may be used to accomplish this performance, for example a solenoid with a pin which extends and retracts as desired, into and out of locking engagement with the sorting tray 30 and/or a guide mount mounted thereto. One or more position sensors 61, 62 may be used to monitor the position of the sorting tray 30, for example the angular position of the sorting tray 30, according to embodiments of the present invention.

A sorting system 4 according to embodiments of the present invention includes a housing 8; a tray 30 tiltably coupled to the housing 8 (e.g. about pivot axis 50), the tray 30 including a top surface 31 configured to receive an object 52; an actuator 54 configured to tilt the tray 30 with respect to the housing 8 to at least a first position 30a at which the object 52, when received by the top surface 31, rolls or slides off of a first end 68 of the tray 30, and a second position 30b at which the object 52, when received by the top surface 31, rolls or slides off of a second end 66 of the tray 30 opposite the first end 68; an object recognition system 104 configured to determine whether the object 52 received by the top surface 31 is a first type of object or a second type of object, wherein the actuator 54 is configured to tilt the tray 30 to the first position 30a when the object 52 is the first type of object, and wherein the actuator 54 is configured to tilt the tray 30 to the second position 30b when the object 52 is the second type of object. According to some embodiments of the present invention, the object recognition system includes a bar code scanner 48 configured to scan a bar code on the object 52, wherein the first type of object is an aluminum beverage container, and wherein the second type of object is a plastic beverage container. According to some embodiments, the object recognition system 104 further includes a camera system 44 configured to determine whether the object 52 is the first type of object or the second type of object based on visual characteristics of the object 52.

According to some embodiments, the first end 68 of the tray 30 is on a first side of a plane defined by an intersection of the tilt axis 50 and a gravitational direction 70, and the second end 66 of the tray 30 is on a second side of such plane. The top surface 31 of the sorting tray may be at least partially concave. The top surface 31 may include a concave curvature extending from the first end 68 to the second end 66, such that a cylindrical object 52 placed onto the top surface 31 with its object axis substantially aligned with the tilt axis 50 is capable of rolling along an entirety of the concave curvature 31 between the first end 68 and the second end. According to some embodiments of the present invention, the housing 8 includes a receiving window 10, and the top surface 31 is configured to receive the object 52 inserted through the receiving window 10. Such systems may further include a light curtain sensor array 56 configured to detect when any object passes through or extends into the receiving window 10. A solenoid 64 may be configured to halt movement of the tray upon detection of any object passing into or through the receiving window, for example by applying a braking mechanism (e.g. by pushing frictionally against the front surface 32 and/or by engaging holes or stops on the tray 30, according to embodiments of the present invention. In some cases, at least one position sensor 61, 62 is configured to sense a tilt angle of the tray 30 with respect to the housing 8. The system 4 may include a first outlet 34 on the first side and a second outlet 35 on the second side. Furthermore, a sensor 42 may be configured to detect when any object passes through or extends into the first outlet 34.

A method for sorting objects according to embodiments of the present invention includes receiving an object 52 on a top surface of a tray 32; scanning the object 52 with a bar code scanner 48 to obtain a bar code number; determining based on the bar code number whether the object 52 is a first type of object or a second type of object; and tilting the tray 30 to cause the object 52 to enter a first outlet 34 based on a determination that the object 52 is the first type of object or to enter a second outlet 35 based on a determination that the object 52 is the second type of object, as illustrated in FIG. 16, for example.

According to embodiments of the present invention, scanning the object 52 with the bar code scanner 48 to obtain the bar code number includes scanning the object 52 for a second time with the bar code scanner 48, the method further including: scanning the object 52 for a first time with the bar code scanner 48, wherein scanning the object 52 for the first time with the bar code scanner does not result in obtaining the bar code number; such method further including tilting the tray 30 to cause the object 52 to move along the top surface 31 to expose a bar code of the object 52 to the bar code scanner 48 prior to scanning the object 52 for the second time (as illustrated in and described with respect to FIG. 15), according to embodiments of the present invention.

In some cases, the object 52 may be substantially cylindrical, and tilting the tray 30 to cause the object 52 to move along the top surface 31 includes tilting the tray 30 to cause the object 52 to roll along the top surface 31 to expose the bar code on the object 52, for example the rocking motion shown in and described with respect to FIG. 15, according to embodiments of the present invention. Tilting the tray 30 to cause the object 52 to roll along the top surface 31 may include tilting the tray 30 to cause the object 52 to roll at least once back and forth along the top surface 31 prior to causing the object 52 to enter either the first outlet 34 or the second outlet 35, according to embodiments of the present invention. According to some embodiments of the present invention, receiving the object 52 on the top surface 31 of the tray 30 includes receiving the object 52 through a receiving window 10, the method further including halting tilting of the tray 30 upon detecting any object passing through or extending into the receiving window 10. Such halting may be accomplished with solenoid 64 and/or other stopping or braking mechanism, according to embodiments of the present invention.

A kiosk according to embodiments of the resent invention includes: a receiving window 10; a sorting system 4 including a tiltable sorting tray 30 and an object recognition system 104, the tiltable sorting tray 30 configured to receive an object 52 inserted through the receiving window 10, wherein the object 52 is one of two or more different types of objects, the sorting system 4 configured to recognize the one of the two or more different types of the object 52 using the object recognition system 104, the sorting system 4 further configured to tilt the tiltable sorting tray 30 in one direction or another to release the object 52 into a particular container based on the recognition. According to some embodiments, the object recognition system 104 is a bar code scanner 48. According to some embodiments of the present invention, the object recognition system 104 is a camera system 44. According to some embodiments of the present invention, the object recognition system 104 is a bar code scanner 48 and a camera system 44.

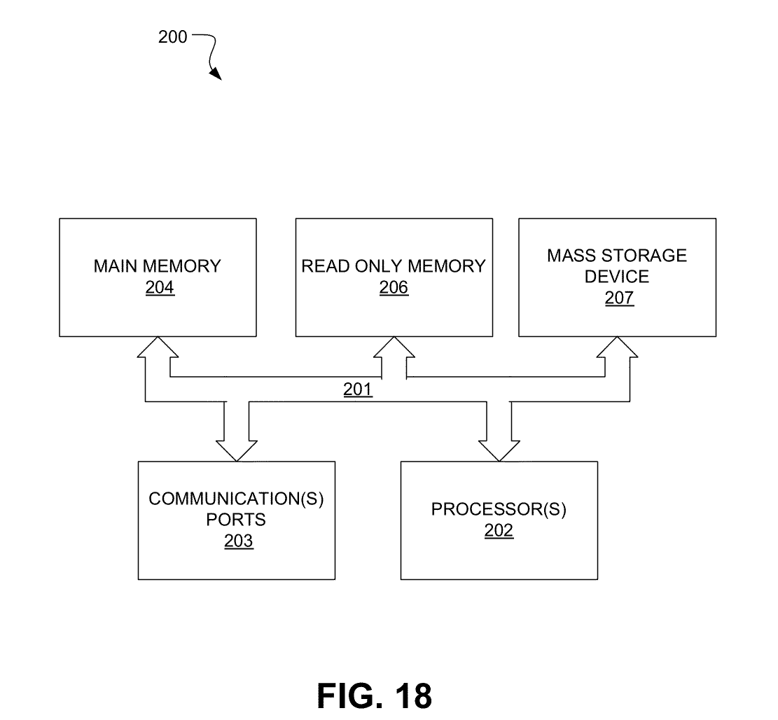

FIG. 18 is an example of a computer system 200 with which embodiments of the present invention may be utilized. Computer system 200 represents an exemplary computer, which may operate as control system 60 in order to receive inputs (e.g. from sensors and the object recognition system 104) and/or provide outputs (e.g. to control the actuator 54 and/or solenoid 64, among others). In this simplified example, the computer system 200 comprises a bus 201 or other communication means for communicating data and control information, and one or more processing devices 202, such as a well known processor, Application Specific Integrated Circuit (ASIC), a field programmable gate array (FPGA), or the like, coupled with bus 201.

In this simplified embodiment, computer system 200 further comprises a random access memory (RAM) or other dynamic storage device (referred to as main memory 204), coupled to bus 201 for storing information and instructions to be executed by processing device 202. Main memory 204 also may be used for storing temporary variables or other intermediate information during execution of instructions by processor(s) 202.

Computer system 200 can also include a read only memory (ROM) 206 and/or other static storage device coupled to bus 201 for storing static information and instructions for processing device 202. A mass storage device 207, such as a magnetic disk or optical disc and its corresponding drive, may also be coupled to bus 201 for storing instructions and information, such as configuration files, a key store and registration database, and the like.

One or more communication ports 203 may also be coupled to bus 201 for supporting network connections and communication of information to/from the computer system 200 by way of a communication network, such as a Local Area Network (LAN), Wide Area Network (WAN), or the Internet, for example. The communication ports 203 may include various combinations of well-known interfaces, such as one or more modems to provide network access, one or more 10/100 Ethernet ports, one or more Gigabit Ethernet ports (fiber and/or copper), or other well-known network interfaces commonly used in internetwork environments. In any event, in this manner, the computer system 200 may be coupled to a number of other network devices, communication devices, clients, NTMs, and/or servers via a conventional communication network infrastructure.

Optionally, operator and administrative interfaces (not shown), such as a display, keyboard, and a cursor control device, may also be coupled to bus 201 to support direct operator interaction with computer system 200. Other operator and administrative interfaces can be provided through network connections connected through communication ports 203. Finally, removable storage media (not shown), such as one or more external or removable hard drives, tapes, floppy disks, magneto-optical discs, compact disk-read-only memories (CD-ROMs), compact disk writable memories (CD-R, CD-RW), digital versatile discs or digital video discs (DVDs) (e.g., DVD-ROMs and DVD+RW), Zip disks, or USB memory devices, e.g., thumb drives or flash cards, may be coupled to bus 201 via corresponding drives, ports or slots.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What is claimed is:

1. A sorting system comprising:
a housing;
a tray tiltably coupled to the housing, the tray comprising a top surface configured to receive an object;
an actuator configured to tilt the tray with respect to the housing to at least a first position at which the object, when received by the top surface, rolls or slides off of a first end of the tray, and a second position at which the object, when received by the top surface, rolls or slides off of a second end of the tray opposite the first end; and
an object recognition system configured to determine whether the object received by the top surface is a first type of object or a second type of object, wherein the actuator is configured to tilt the tray to the first position when the object is the first type of object, and wherein the actuator is configured to tilt the tray to the second position when the object is the second type of object.

2. The sorting system of claim 1, wherein the object recognition system comprises a bar code scanner configured to scan a bar code on the object, wherein the first type of object is an aluminum beverage container, and wherein the second type of object is a plastic beverage container.

3. The sorting system of claim 2, wherein the object recognition system further comprises a camera system configured to determine whether the object is the first type of object or the second type of object based on visual characteristics of the object.

4. The sorting system of claim 1, wherein the first end of the tray is on a first side of a plane defined by an intersection of the tilt axis and a gravitational direction, and wherein the second end of the tray is on a second side of the plane.

5. The sorting system of claim 1, wherein the top surface is at least partially concave.

6. The sorting system of claim 1, wherein the top surface comprises a concave curvature extending from the first end to the second end, such that a cylindrical object placed onto the top surface with its object axis substantially aligned with the tilt axis is capable of rolling along an entirety of the concave curvature between the first and second ends.

7. The sorting system of claim 1, wherein the housing comprises a receiving window, and wherein the top surface is configured to receive the object inserted through the receiving window.

8. The sorting system of claim 7, further comprising a light curtain sensor array configured to detect when any object passes through or extends into the receiving window.

9. The sorting system of claim 8, further comprising a solenoid configured to halt movement of the tray upon detection of any object passing into or through the receiving window.

10. The sorting system of claim 1, further comprising at least one position sensor configured to sense a tilt angle of the tray with respect to the housing.

11. The sorting system of claim 4, further comprising a first outlet on the first side and a second outlet on the second side.

12. The sorting system of claim 11, further comprising a sensor configured to detect when any object passes through or extends into the first outlet.

13. A method for sorting objects, the method comprising:
receiving an object on a top surface of a tray;
scanning the object with a bar code scanner to obtain a bar code number;
determining based on the bar code number whether the object is a first type of object or a second type of object; and
tilting the tray to cause the object to enter a first outlet based on a determination that the object is the first type of object or to enter a second outlet based on a determination that the object is the second type of object.

14. The method of claim 13, wherein scanning the object with the bar code scanner to obtain the bar code number comprises scanning the object for a second time with the bar code scanner, the method further comprising:
scanning the object for a first time with the bar code scanner, wherein scanning the object for the first time with the bar code scanner does not result in obtaining the bar code number; and
tilting the tray to cause the object to move along the top surface to expose a bar code of the object to the bar code scanner prior to scanning the object for the second time.

15. The method of claim 14, wherein the object is substantially cylindrical, and wherein tilting the tray to cause the object to move along the top surface comprises tilting the tray to cause the object to roll along the top surface to expose the bar code on the object.

16. The method of claim 15, wherein tilting the tray to cause the object to roll along the top surface comprises tilting the tray to cause the object to roll at least once back and forth along the top surface prior to causing the object to enter either the first outlet or the second outlet.

17. The method of claim 13, wherein receiving the object on the top surface of the tray comprises receiving the object through a receiving window, the method further comprising halting tilting of the tray upon detecting any object passing through or extending into the receiving window.

18. A kiosk comprising:
a receiving window; and
a sorting system comprising a tiltable sorting tray and an object recognition system, the tiltable sorting tray configured to receive an object inserted through the receiving window, wherein the object is one of two or more different types of objects, the sorting system configured to recognize the one of the two or more different types of the object using the object recognition system, the sorting system further configured to tilt the tiltable sorting tray in one direction or another to release the object into a particular container based on the recognition.

19. The kiosk of claim 18, wherein the object recognition system is a bar code scanner.

20. The kiosk of claim 18, wherein the object recognition system is a camera system.

21. The kiosk of claim 18, wherein the object recognition system is a bar code scanner and a camera system.
